(19) United States
(12) Patent Application Publication
(10) Pub. No.: US 2023/0066713 A1
(43) Pub. Date: Mar. 2, 2023

(54) ASSEMBLY FOR FACILITATING ELECTRICAL CONNECTION BETWEEN A CIRCUIT BREAKER AND CABLES INSIDE A PANELBOARD

(71) Applicant: Appleton Grp LLC, Rosemont, IL (US)

(72) Inventors: Vaibhav B. Hande, Pune (IN); Timothy E. Graff, Arlington Heights, IL (US)

(21) Appl. No.: 17/735,391

(22) Filed: May 3, 2022

(30) Foreign Application Priority Data
Aug. 30, 2021 (IN) 202121039191

(51) Int. Cl. H02B 1/04; H01R 4/56

(52) U.S. Cl. CPC H02B 1/04; H01R 4/56

(57) ABSTRACT

The present disclosure relates to the field of electrical engineering and discloses an assembly (100) for facilitating safe electrical connection between a circuit breaker (10) and a plurality of electrical connectors (20) inside an electrical panel board (30). The assembly comprises a plurality of connecting members (102) and a support block (104). Each connecting member (102) has a first connecting end (102a) connected to the terminals (10c) of the circuit breaker (10) and a second connecting end (102b) connected to the electrical connectors (20). The support block (104) comprises a plurality of projecting surfaces (104a), slots (104b) defined between the projecting surfaces (104a), and elongated members (104c). The slots (104b) provide a rigid support to the electrical connectors (20) to prevent bending and rotation of the connectors (20) on being subjected to a high torque. The elongated members (104c) isolate the connecting members (102) from each other.

### FIELD

The present disclosure generally relates to electrical cable connection assemblies. More particularly, the present disclosure relates to an assembly for facilitating electrical connection between a circuit breaker and cables inside a panelboard.

### BACKGROUND

The background information herein below relates to the present disclosure but is not necessarily prior art.

An electrical panelboard is a component of an electricity supply system that comprises multiple branch circuits which divide power from an incoming power feed for its distribution. Each branch circuit is provided with a protecting and/or switching device (for e.g., circuit breaker). The panelboards further include an arrangement for electrically connecting the switching/protecting device with the field cables.

Conventional connection arrangements include electrical breakers with glands and solid rods with wire terminations. The drawback of this arrangement is that it is not suitable to be directly connected to a busbar mechanism. Further, the existing arrangement is suitable for use with breakers of up to 150 A only and can accommodate wire of sizes up to 1/0 only.

In addition to the above, the existing arrangements suffer from safety issues as the field cables or internal load side cables come close to each other when they are torqued, thereby reducing the electrical clearance which further compromises safety.

Further, the existing arrangements lack appropriate mechanical support which leads to the bending of the electrical connectors. Due to inadequate support, the electrical connectors can come near the mounting pan surface of the panelboard. The mounting pans are typically grounded whereas the electrical connectors are live. Therefore, a reduction in the distance between the mounting pan surface and the electrical connectors ultimately leads to a reduction in the electrical clearance and may cause sparking, which is not desired.

Moreover, the conventional cable connection arrangements suffer from lack of appropriate mechanical support at walls/F-Frame of circuit breaker housing, which leads to the rotation of electrical connectors at the fulcrum. Due to this, the electrical connectors are prone to exert undue forces on the walls which can cause cracking of the walls. The rotation of electrical connectors from their fulcrum can not only compromise the firm contact of the live parts and the clearance between connectors but can also increase possibility of arcing and sparking.

The conventional arrangements do not provide an easy access to the fasteners, thereby further compromising the firm contact of the live parts.

The existing arrangements do not allow circuit breakers to be used for high amperages such as 175 A, 200 A and 225 A. Further, it is practically not possible to accommodate wire size of 4/0, 250MCM and 300MCM in the conventional arrangements.

In addition to the above, existing arrangements necessitate the use of heat dissipators for high amperages such as 100 A, 110 A, 125 A and 150 A, which adds to the space requirements and cost of the panelboard assembly.

Therefore, there is felt a need for an assembly for facilitating safe electrical connection between a circuit breaker and cables inside a panelboard that alleviates the aforementioned drawbacks.

### OBJECTS

Some of the objects of the present disclosure, which at least one embodiment herein satisfies are as follows:

An object of the present disclosure is to provide an assembly for facilitating electrical connection between a circuit breaker and cables inside a panelboard.

Another object of the present disclosure is to provide an assembly for facilitating electrical connection between a circuit breaker and cables inside a panelboard that gives a robust and rigid support to electrical/cable connectors.

Still another object of the present disclosure is to provide an assembly for facilitating safe electrical connection between a circuit breaker and cables inside a panelboard.

Yet another object of the present disclosure is to provide an assembly for facilitating electrical connection between a circuit breaker and cables inside a panelboard that prevents bending and rotation of the cable connectors on being subjected to a high torque.

Still another object of the present disclosure is to provide an assembly that facilitates electrical cables having a cross-sectional area of up to 300 MCM to be terminated on the electrical connectors.

Yet another object of the present disclosure is to provide an assembly for facilitating electrical connection between a circuit breaker and cables that is suitable for use with the circuit breaker having a current rating of up to 225 Amperes.

Still another object of the present disclosure is to provide an assembly that facilitates safe electrical connection between an explosion proof circuit breaker and electrical cables inside a panelboard.

Yet another object of the present disclosure is to provide an assembly that provides adequate separation or clearance between the electrical connectors to ensure maintenance of the terminal temperature within certification standard acceptance value and cable insulation compliance for 90° C. ratings.

Still another object of the present disclosure is to provide an assembly which facilitates use of a single circuit breaker for current ratings of 100 A, 110 A, 125 A, 150 A, 175 A, 200 A and 225 A, thereby eliminating the requirement of multiple inventories.

Yet another object of the present disclosure is to provide an assembly for facilitating electrical connection between a circuit breaker and cables that is cost-effective.

Still another object of the present disclosure is to provide an assembly for facilitating electrical connection between a circuit breaker and cables that is compact.

Other objects and advantages of the present disclosure will be more apparent from the following description when read in conjunction with the accompanying figures, which are not intended to limit the scope of the present disclosure.

### SUMMARY

The present disclosure envisages an assembly for facilitating safe electrical connection between a circuit breaker and a plurality of electrical connectors inside an electrical panel board. The circuit breaker has a plurality of terminals. The assembly comprises a plurality of connecting members and a support block. Each of the connecting members has a first connecting end and a second connecting end. The first connecting end is configured with a first hole for allowing connection to the terminals of the circuit breaker by means of a first fastener. The second connecting end is configured with a second hole for allowing connection to the electrical connectors by means of a second fastener. The support block comprises a plurality of projecting surfaces, a plurality of slots defined between the projecting surfaces, and a plurality of elongated members. The slots are configured to provide a rigid support to the electrical connectors to prevent bending and rotation of the connectors on being subjected to a high torque. The elongated members extend from the intermediate projecting surfaces. The elongated members are configured to isolate the connecting members from each other. Each of the projecting surfaces of the support block is configured with a third hole to facilitate mounting of the support block on a mounting pan of the panel board.

In an embodiment, the second connecting end of the connecting members includes a first notch. The first notch is configured to engage with the electrical connector and prevent the rotation thereof. The second hole is a simple hole configured to limit the longitudinal and lateral movement of the second connecting end of the plurality of connecting members. Further, at least one connecting member is configured with a second notch at the first connecting end thereof. The second notch is configured to engage with the body of the circuit breaker to prevent lateral movement of the connecting member and to safeguard the anti-rotation feature provided by the first notch.

The connecting members can be Z-shaped, S-shaped, or flat.

The second hole of the connecting members is an oblong through hole or a circular through hole.

The first connecting end and the second connecting end of the connecting members are configured to rest on top of the circuit breaker terminals and the electrical connectors respectively, to facilitate the first fasteners and the second fasteners to be accessed from the top.

In an embodiment, the support block is made of glass reinforced thermoset polyester sheet material.

In an embodiment, the assembly comprises a moulded terminal shield configured to be mounted on the circuit breaker. The terminal shield comprises a base and a vertical face supported on the base. The vertical face includes a plurality of openings configured to facilitate connection of the connecting members to the electrical connectors and a plurality of spacing members extending from the vertical face and disposed between the openings to provide separation between the electrical connectors.

In another embodiment, the assembly comprises a plurality of vertical barriers fitted to the body of the circuit breaker to provide a separation between the electrical connectors. The vertical barriers may be supported with a base.

In an embodiment, each of the connecting members is configured to be flush with a back wall and two side walls of the body of an F-Frame circuit breaker. The walls are configured to prevent rotation of the connecting members and are further configured to prevent loosening of the first fasteners.

Advantageously, the assembly facilitates electrical cables having a cross-sectional area of up to 300 MCM to be terminated on the electrical connectors.

Advantageously, the assembly is suitable for use with the circuit breaker having a current rating of up to 225 Amperes.

The present disclosure further envisages a circuit breaker module equipped with the assembly for facilitating safe electrical connection of a circuit breaker with a plurality of electrical connectors inside an electrical panel board.

### BRIEF DESCRIPTION OF THE ACCOMPANYING DRAWING

An assembly for facilitating electrical connection between a circuit breaker and cables inside a panelboard will now be described with the help of the accompanying drawings, in which:

FIG. 1 illustrates a schematic diagram of a panelboard comprising an assembly for facilitating electrical connection between a circuit breaker and cables, in accordance with the present disclosure;

FIG. 2 illustrates a cross-sectional side view of the panelboard of FIG. 1, in accordance with the present disclosure;

FIG. 3A illustrates an isometric view of an arrangement comprising a plurality of electrical connectors connected to the terminals of a circuit breaker via a set of connecting members of the assembly of FIG. 1;

FIG. 3B illustrates an exploded isometric view of the arrangement of FIG. 3A;

FIG. 4A illustrates a top view of the arrangement of FIG. 3A;

FIG. 4B illustrates a side view of the arrangement of FIG. 3A;

FIG. 4C illustrates a front view of the arrangement of FIG. 3A;

FIG. 4D illustrates a bottom view of the arrangement of FIG. 3A;

FIG. 5 illustrates a cross-sectional view of the arrangement of FIG. 3A;

FIGS. 6A, 6B and 6C illustrate schematic views of a left, a middle, and a right connecting member respectively, of the assembly of FIG. 1;

FIGS. 7A, 7B, 7C, 7D, 7E, and 7F illustrate top, left, front, right, bottom, and back side schematic views of a support block of the assembly of FIG. 1;

FIG. 8 illustrates a cross-sectional view of the support block of the assembly of FIG. 1;

FIGS. 9A and 9B respectively illustrate left-side and right-side isometric views of the support block of the assembly of FIG. 1;

FIGS. 10A and 10B respectively illustrate schematic views of different panelboards equipped with the assembly of FIG. 1;

FIG. 11A illustrates a moulded terminal shield mounted on a circuit breaker for providing separation between the electrical connectors inside a panelboard;

FIG. 11B illustrates a schematic view of the moulded terminal shield of FIG. 11A;

FIGS. 12A, 12B, and 12C illustrate schematic views of an insulation sheet that can be affixed to a circuit breaker between the electrical connectors for providing separation between the electrical connectors;

FIGS. 13A and 13B illustrate a schematic view of a solid electrical connector with a plastic insulator for separation with respect to the other electrical connectors inside a panelboard, in accordance with one embodiment of the present disclosure;

FIGS. 14A, 14B and 14C illustrate a schematic view of a solid electrical connector with a plastic insulator for separation with respect to the other electrical connectors inside a panelboard, in accordance with another embodiment of the present disclosure;

FIGS. 15A, 15B, and 15C illustrate schematic views of a two-piece insulator comprising a moulded base part and an interphase barrier for providing separation between the electrical connectors; and

FIGS. 16A, 16B, and 16C illustrate schematic views of a two-piece insulator comprising a moulded base part fastened to an interphase barrier for providing separation between the electrical connectors.

### LIST OF REFERENCE NUMERALS

100—Assembly

10—Circuit breaker

10a—Back wall of circuit breaker

10b—Side walls of circuit breaker

10c—Terminals

20—Electrical connectors

30—Panelboard

30a—Mounting pan

102—Connecting members

102a—First connecting end of connecting member

102b—Second connecting end of connecting member

104—Support block

104a—Projecting surfaces

104b—Slots

104c—Elongated members

106a—First hole

106b—Second hole

108a—First fasteners

108b—Second fasteners

110a—First notch

110b—Second notch

112—Electrical cables

114—Third hole

116—Moulded terminal shield

116a—Base

116b—Vertical face

116c—Spacing members

116d—Openings

118—Insulation sheet

120, 122—Plastic insulators

124a, 126a—Vertical barrier

124b, 126b—Supporting base

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a”, “an”, and “the” may be intended to include the plural forms as well, unless the context clearly suggests otherwise. The terms “comprises”, “comprising”, “including”, and “having”, are open ended transitional phrases and therefore specify the presence of stated features, elements, modules, units and/or components, but do not forbid the presence or addition of one or more other features, elements, components, and/or groups thereof.

When an element is referred to as being “mounted on”, “engaged to”, “connected to”, or “coupled to” another element, it may be directly on, engaged, connected or coupled to the other element. As used herein, the term “and/or” includes any and all combinations of one or more of the associated listed elements.

The terms first, second, third, etc., should not be construed to limit the scope of the present disclosure as the aforementioned terms may be only used to distinguish one element, component, region, or section from another element, component, region, or section. Terms such as first, second, third etc., when used herein do not imply a specific sequence or order unless clearly suggested by the present disclosure.

The conventional cable connection arrangements within the electrical panelboards suffer from various problems such as unsuitability for direct connection on a busbar, unsuitability for use with breakers of up to 250 A rating, restriction of wire sizes that can be accommodated, safety issues resulting from movement or rotation of electrical connectors and cables, lack of appropriate mechanical support for the electrical connectors, lack of appropriate mechanical support at walls/F-Frame of circuit breaker housing, inadequate access to the fasteners, requirement of the use of heat dissipators, and high cost and space requirement.

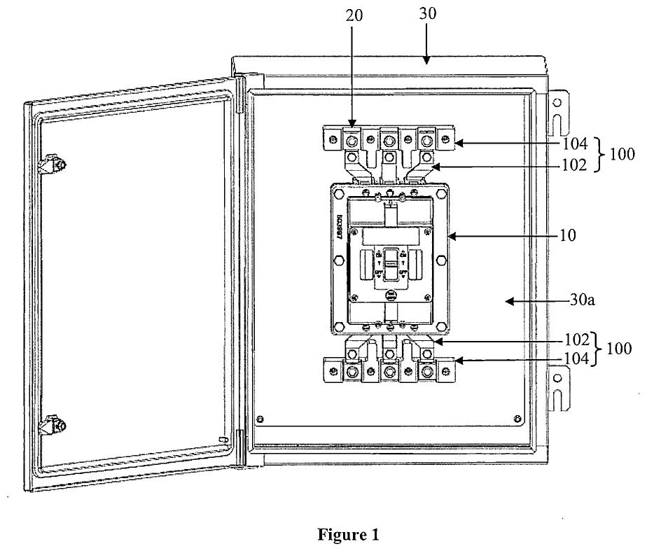

In order to alleviate the aforementioned shortcomings of the existing assemblies, an assembly (hereinafter referred to as “assembly 100”) for facilitating electrical connection between a circuit breaker and cables inside a panelboard is now being described with reference to FIG. 1 through FIG. 16C.

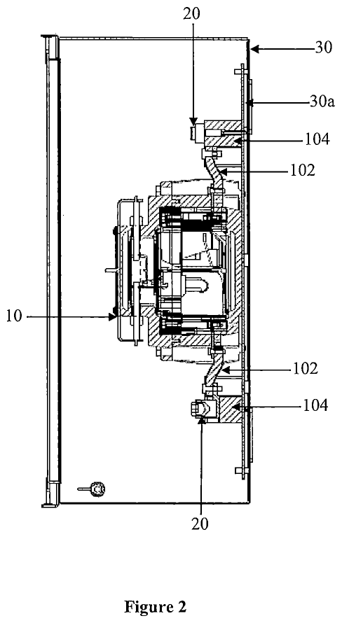

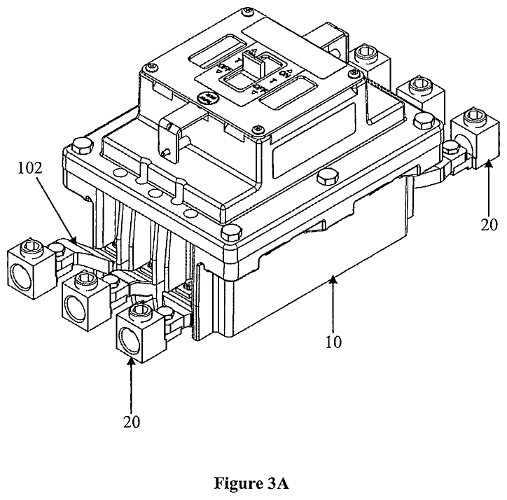

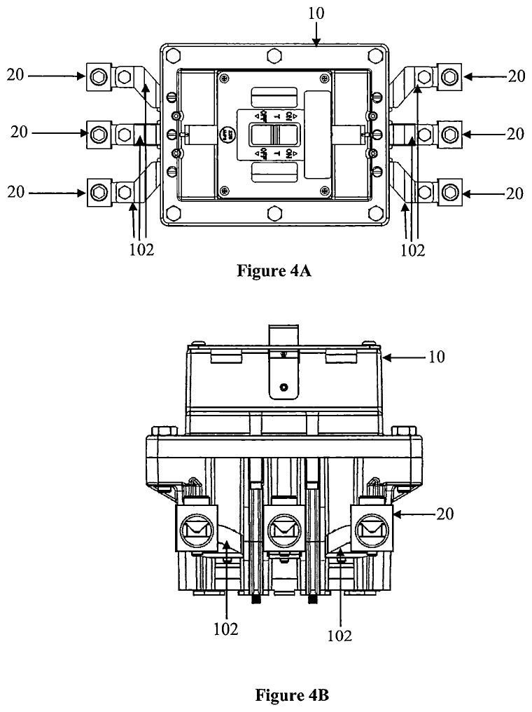

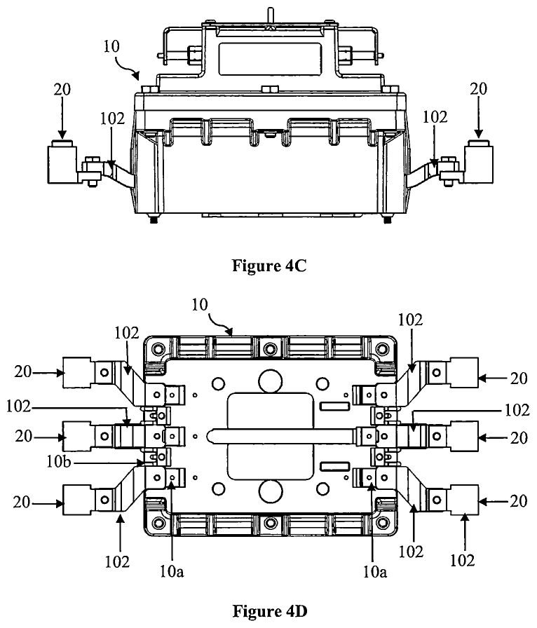

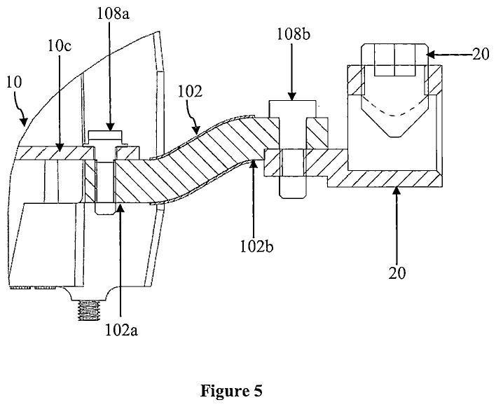

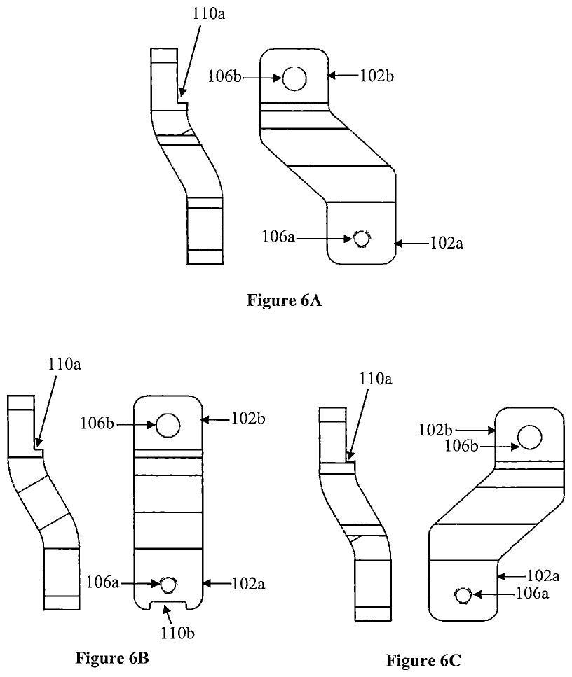

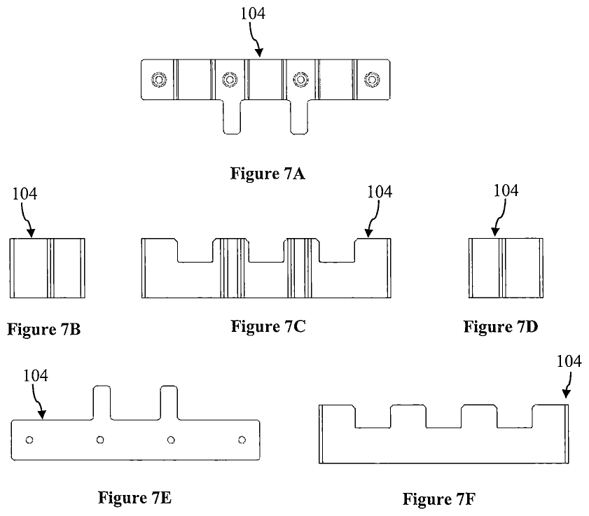

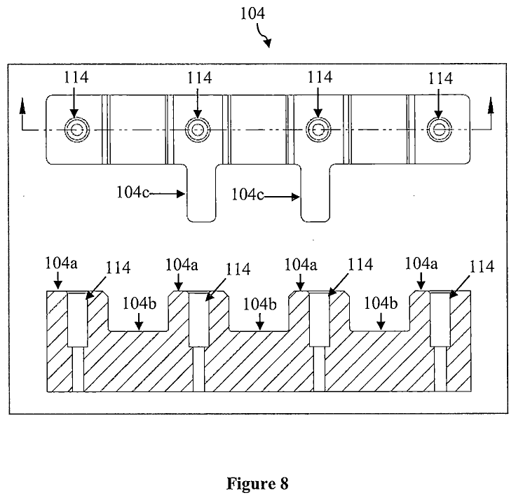

Referring to FIGS. 1 and 2, the assembly 100 comprises a plurality of connecting members 102 and a support block 104. As shown in FIG. 5, the circuit breaker 10 includes a plurality of terminals 10c. Each of the connecting members 102 has a first connecting end 102a and a second connecting end 102b. FIGS. 6A, 6B and 6C illustrate schematic views of a left, a middle and a right connecting member 102 respectively for a three-phase circuit breaker. As shown in FIGS. 6A to 6C, the first connecting end 102a of each connecting member 102 is configured with a first hole 106a for allowing connection to the terminals 10c of the circuit breaker 10 by means of a first fastener 108a. The second connecting end 102b of each connecting member 102 is configured with a second hole 106b for allowing connection to the electrical connectors 20 by means of a second fastener 108b. This connection is clearly shown in FIGS. 3A-3B, 4A-4D, and FIG. 5. The electrical connectors 20 receive and terminate field cables 112 as shown in the panelboard diagrams of FIG. 10A and 10B. Referring to FIGS. 8, 9A and 9B, the support block 104 comprises a plurality of projecting surfaces 104a, a plurality of slots 104b, and a plurality of elongated members 104c. Each of the projecting surfaces 104a of the support block 104 is configured with a third hole 114 to facilitate mounting of the support block 104 on a mounting pan 30a of the panel board 30. The slots 104b are defined between the projecting surfaces 104a. The slots 104b are configured to provide a rigid support to the electrical connectors 20 to prevent bending and rotation of the connectors 20 on being subjected to a high torque. The electrical connectors 20 may be subjected to a high torque, for example, when an operating personnel performs field wiring installation. The elongated members 104c extend from the intermediate projecting surfaces 104c of the support block 104. The elongated members 104c are configured to isolate the connecting members 102 from each other. FIGS. 7A-7F indicate various views of the support block 104 of the assembly 100.

Referring again to FIGS. 6A to 6C, the second connecting end 102b of the connecting members 102 includes a first notch 110a. The first notch 110a is configured to engage with the electrical connector 20 and prevent the rotation thereof. In an embodiment, the second hole 106b is a simple hole configured to limit the longitudinal and lateral movement of the second connecting end 102b of the plurality of connecting members 102. Further, at least one connecting member 102 is configured with a second notch 110b at the first connecting 102a end thereof. The second notch 110b is configured to engage with the body of the circuit breaker 10 to prevent lateral movement of the connecting member 102 and to safeguard the anti-rotation feature provided by the first notch 110a. In a preferred embodiment, the second notch 110b is provided on the middle connecting member(s) of the assembly 100.

The connecting members 102 can be Z-shaped, S-shaped, or flat.

In an embodiment, the second hole 106b of the connecting members 102 is an oblong through hole or a circular through hole.

In an embodiment, the third hole 114 is a stepped hole as shown in FIG. 8.

In an embodiment, the support block 104 is made of glass reinforced thermoset polyester sheet material. The connecting members 102 are made of a metal selected from the group consisting of, but not limited to, copper, aluminium, silver, nickel, gold, and like.

Advantageously, the first connecting end 102a and the second connecting end 102b of the connecting members 102 are configured to rest on top of the circuit breaker terminals 10c and the electrical connectors 20 respectively, to facilitate the first fasteners 108a and the second fasteners 108b to be accessed from the top, thereby providing ease of access to the fasteners (108a, 108b).

Advantageously, the assembly 100 facilitates electrical cables 112 having a cross-sectional area of up to 300 MCM to be terminated on the electrical connectors 20.

Advantageously, the assembly 100 is suitable for use with the circuit breaker 10 having a current rating of up to 225 Amperes.

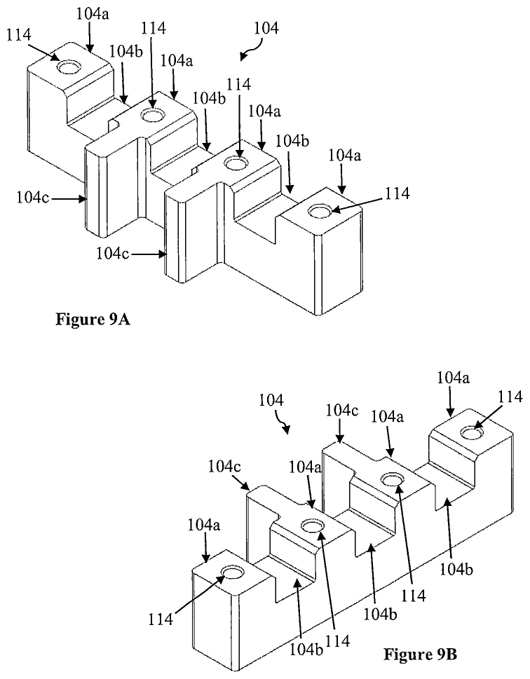

To provide physical separation between the electrical connectors 20, various provisions alternative to the elongated members 104c of the support block 104 may be provided. These alternative provisions are described below with reference to FIGS. 11A to 16C.

Referring to FIGS. 11A and 11B, in one embodiment, the assembly 100 comprises a moulded terminal shield 116 configured to be mounted on the circuit breaker 10. The terminal shield 116 includes a base 116a and a vertical face 116b supported on the base 116a. The vertical face 116b includes a plurality of openings 116d and a plurality of spacing members 116c. The openings 116d are configured to facilitate connection of the connecting members 102 to the electrical connectors 20. The spacing members 116c extend from the vertical face 116b and are disposed between the openings 116d to provide separation between the electrical connectors 20.

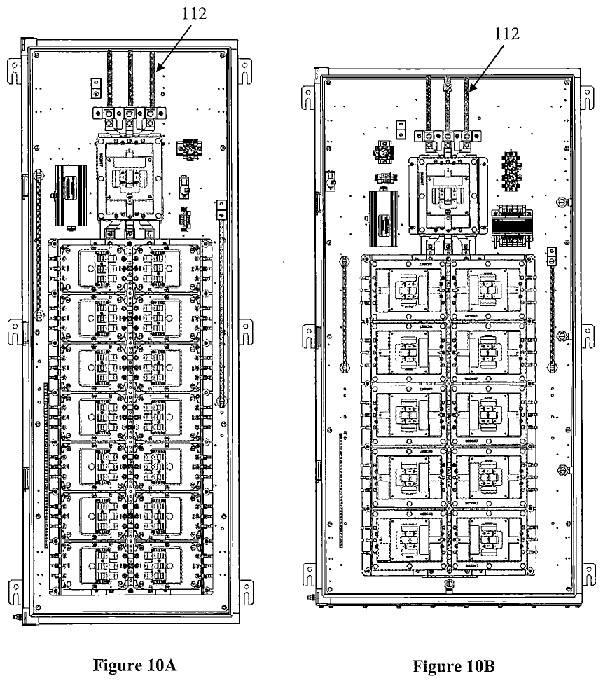

In another embodiment, referring to FIGS. 12A to 12C, the assembly 100 comprises an insulation sheet 118 affixed to the circuit breaker 10 between each of the adjacent electrical connectors 20.

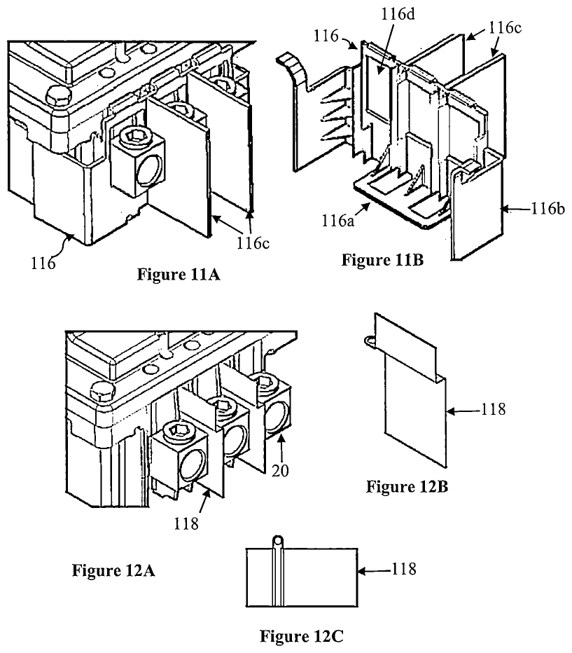

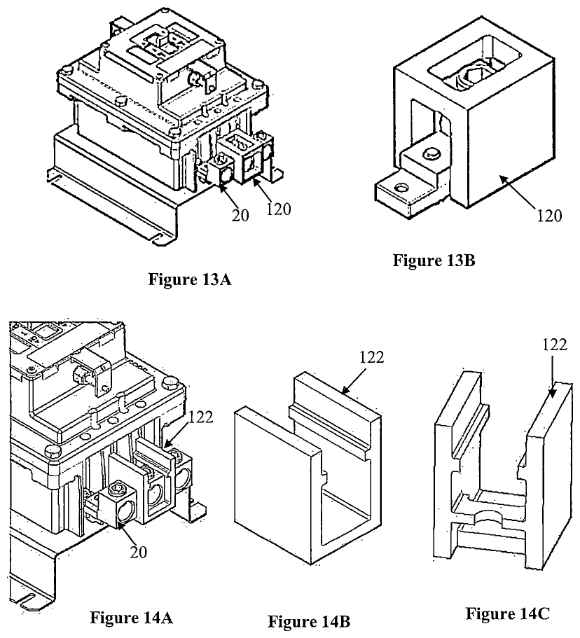

Alternatively, plastic insulations (120, 122) with three or four walls may be provided as shown in FIGS. 13A to 14C to provide separation between the electrical connectors 20.

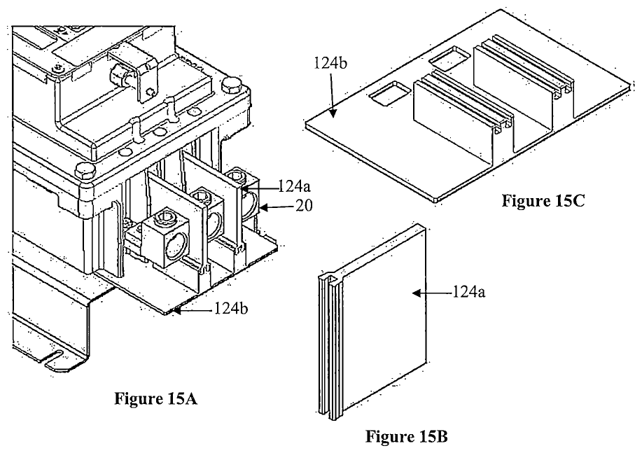

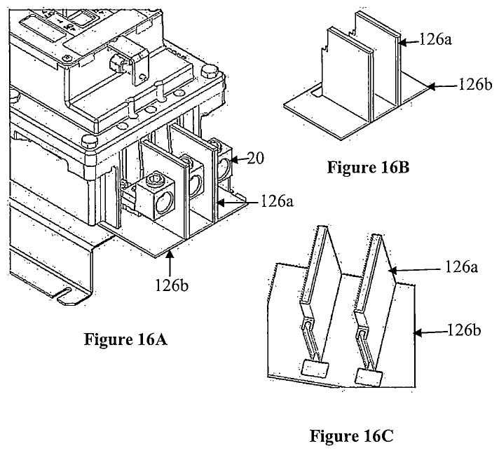

In yet another embodiment, the assembly 100 includes two-piece insulators comprising a plurality of vertical/interphase barriers fitted to the body of the circuit breaker 10 between the electrical connectors 20 to provide separation between the connectors 20. As shown in FIGS. 15A, 15B, and 15C, each of the two-piece insulators may include a moulded base part 124b having a groove for holding the vertical barrier 124a. Alternatively, as shown in FIGS. 16A, 16B, and 16C, each of the two-piece insulators may include a moulded base part 126b fastened to an interphase barrier 126a for providing separation between the electrical connectors 20.

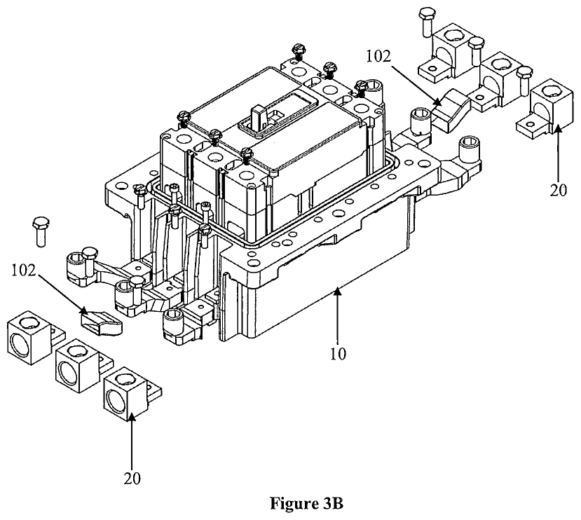

Advantageously, the assembly 100 may be used with an F-Frame circuit breaker. In this case, each of the connecting members 102 is configured to be flush with a back wall 10a and two side walls 10b of the body of the F-Frame circuit breaker as shown in FIG. 4D. The walls (10a, 10b) are configured to prevent rotation of the connecting members 102 and are further configured to prevent loosening of the first fasteners 108a.

The present invention further envisages a circuit breaker module equipped with the assembly 100 for facilitating safe electrical connection of a circuit breaker 10 with a plurality of electrical connectors 20 inside an electrical panelboard 30.

The assembly 100 can be used in panelboards of all types, such as power distribution panels, motor starter panels, fibre patch panels, etc., which incorporate switches of any type such as circuit breaker, Ground Fault Circuit Interrupter device, etc. The assembly 100 mounted in RF and RQ panelboard models is shown in FIGS. 10A and 10B.

The assembly 100 prevents bending and rotation of the electrical connectors 20 on being subjected to a high torque by giving a robust and rigid support to electrical connectors 20.

Further, it facilitates the use of a single circuit breaker for current ratings of 100 A, 110 A, 125 A, 150 A, 175 A, 200 A and 225 A, thereby eliminating the requirement of multiple inventories. Thus, a universal breaker can be designed for supporting multiple amperages.

The assembly 100 provides adequate separation or clearance between the electrical connectors 20 to ensure maintenance of the terminal temperature within certification standard acceptance value and cable insulation compliance for 90° C. ratings. Thus, the assembly 100 can be used for higher amperage requirement and connection of large size cables.

The assembly 100 can be used with an explosion proof circuit breaker having a current rating of up to 225 Amperes. The 225 A breaker module can be designed to be suitable for both US (Class 1 Div. 2) and Canadian Markets (Class 1 Zone 1).

The assembly is compact and cost-effective.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

Technical Advancements

The present disclosure described herein above has several technical advantages including, but not limited to, an assembly for facilitating electrical connection between a circuit breaker and cables inside a panelboard that:
gives a robust and rigid support to electrical/cable connectors;
is safe;
prevents bending and rotation of the cable connectors on being subjected to a high torque;
facilitates electrical cables having a cross-sectional area of up to 300 MCM to be terminated on the electrical connectors;
is suitable for use with the circuit breaker having a current rating of up to 225 Amperes;
is suitable for use with an explosion proof circuit breaker having a current rating of up to 225 Amperes;
provides adequate separation or clearance between the electrical connectors to ensure maintenance of the terminal temperature within certification standard acceptance value and cable insulation compliance for 90° C. ratings;
facilitates use of a single circuit breaker for current ratings of 100 A, 110 A, 125 A, 150 A, 175 A, 200 A and 225 A, thereby eliminating the requirement of multiple inventories;
is cost-effective; and
compact.

The disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element or group of elements, but not the exclusion of any other element or group of elements.

The use of the expression “at least” or “at least one” suggests the use of one or more elements or ingredients or quantities, as the use may be in the embodiment of the disclosure to achieve one or more of the desired objects or results.

While considerable emphasis has been placed herein on the components and component parts of the preferred embodiments, it will be. appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

We claim:

1. An assembly (100) for facilitating safe electrical connection between a circuit breaker (10) and a plurality of electrical connectors (20) inside an electrical panel board (30), said circuit breaker (10) having a plurality of terminals (10c), said assembly (100) comprising:
a. a plurality of connecting members (102), each connecting member (102) having a first connecting end (102a) and a second connecting end (102b), said first connecting end (102a) configured with a first hole (106a) for allowing connection to the terminals (10c) of said circuit breaker (10) by means of a first fastener (108a), said second connecting end (102b) configured with a second hole (106b) for allowing connection to said electrical connectors (20) by means of a second fastener (108b);
b. a support block (104) comprising:
a plurality of projecting surfaces (104a);
a plurality of slots (104b) defined between said projecting surfaces (104a), said slots (104b) configured to provide a rigid support to said electrical connectors (20) to prevent bending and rotation of the connectors (20) on being subjected to a high torque; and
a plurality of elongated members (104c) extending from the intermediate projecting surfaces (104c), said elongated members (104c) configured to isolate said connecting members (102) from each other.

2. The assembly (100) as claimed in claim 1, wherein said second connecting end (102b) of said connecting members (102) includes a first notch (110a), said first notch (110a) configured to engage with said electrical connector (20) and prevent the rotation thereof.

3. The assembly (100) as claimed in claim 2, wherein said second hole (106b) is a simple hole configured to limit the longitudinal and lateral movement of said second connecting end (102b) of said plurality of connecting members (102).

4. The assembly (100) as claimed in claim 2, wherein at least one connecting member (102) is configured with a second notch (110b) at the first connecting (102a) end thereof, said second notch (110b) configured to engage with the body of said circuit breaker (10) to prevent lateral movement of said connecting member (102) and to safeguard the anti-rotation feature provided by said first notch (110a).

5. The assembly (100) as claimed in claim 1, wherein said connecting members (102) are Z-shaped, S-shaped or flat.

6. The assembly (100) as claimed in claim 1, wherein said second hole (106b) of said connecting members (102) is an oblong through hole or a circular through hole.

7. The assembly (100) as claimed in claim 1, wherein said first connecting end (102a) and said second connecting end (102b) of said connecting members (102) are configured to rest on top of said circuit breaker terminals (10c) and said electrical connectors (20) respectively, to facilitate said first fasteners (108a) and said second fasteners (108b) to be accessed from the top.

8. The assembly (100) as claimed in claim 1, which facilitates electrical cables (112) having a cross-sectional area of up to 300 MCM to be terminated on said electrical connectors (20).

9. The assembly (100) as claimed in claim 1, which is suitable for use with the circuit breaker (10) having a current rating of up to 225 Amperes.

10. The assembly (100) as claimed in claim 1, wherein each of said projecting surfaces (104a) of said support block (104) is configured with a third hole (114) to facilitate mounting of said support block (104) on a mounting pan (30a) of said panel board (30).

11. The assembly (100) as claimed in claim 1, wherein said support block (104) is made of glass reinforced thermoset polyester sheet material.

12. The assembly (100) as claimed in claim 1, which comprises a moulded terminal shield (116) configured to be mounted on said circuit breaker (10), said terminal shield (116) having:
a. a base (116a); and
b. a vertical face (116b) supported on said base (116a), said vertical face having:
a plurality of openings (116d) configured to facilitate connection of said connecting members (102) to said electrical connectors (20); and
a plurality of spacing members (116c) extending from said vertical face (116b) and disposed between said openings (116d) to provide separation between said electrical connectors (20).

13. The assembly (100) as claimed in claim 1, which comprises a plurality of vertical barriers fitted to the body of said circuit breaker (10) to provide a separation between said electrical connectors (20).

14. The assembly (100) as claimed in claim 12, wherein said vertical barriers are supported with a base.

15. The assembly (100) as claimed in claim 1, wherein each of said connecting members (102) is configured to be flush with a back wall (10a) and two side walls (10b) of the body of an F-Frame circuit breaker, said walls (10a, 10b) configured to prevent rotation of said connecting members (102), and further configured to prevent loosening of said first fasteners (108a).

16. A circuit breaker module equipped with the assembly (100) as claimed in claim 1 for facilitating safe electrical connection of a circuit breaker (10) with a plurality of electrical connectors (20) inside an electrical panel board (30).
